(19) United States
(12) Patent Application Publication
(10) Pub. No.: US 2015/0264635 A1
(43) Pub. Date: Sep. 17, 2015

(54) SYSTEMS AND METHODS FOR PERFORMING RECURSIVE BETTER SYSTEM RESELECTION

(71) Applicant: QUALCOMM Incorporated, San Diego, CA (US)

(72) Inventor: Cat C. Le, San Diego, CA (US)

(73) Assignee: QUALCOMM Incorporated, San Diego, CA (US)

(21) Appl. No.: 14/206,917

(22) Filed: Mar. 12, 2014

(51) Int. Cl. H04W 48/16; H04W 8/06

(52) U.S. Cl. CPC H04W 48/16; H04W 8/06

(57) ABSTRACT

Embodiments of the present invention include devices, systems and methods for performing recursive Better Cell Reselection (BSR). For example, a method for wireless communication is described. The method includes performing a BSR scan for systems. The method also includes finding a base system to camp on that is not a most preferred system. The method further includes determining whether to perform a recursive BSR scan starting from the base system found in the prior BSR scan. Other aspects, embodiments, and features are also claimed and described.

### TECHNICAL FIELD

The technology discussed below relates generally to communication systems, and more specifically to systems and methods for performing recursive better system reselection (BSR). Implementation of certain aspects of the technology discussed below can enable improved communication network selection and efficient use of power resources.

### BACKGROUND

Wireless communication systems have become an important means by which many people worldwide have come to communicate. A wireless communication system may provide communication for a number of wireless communication devices, each of which may be serviced by a base station.

In the last several decades, the use of wireless communication devices has become common. In particular, advances in electronic technology have reduced the cost of increasingly complex and useful wireless communication devices. Cost reduction and consumer demand have proliferated the use of wireless communication devices such that they are practically ubiquitous in modern society. As the use of wireless communication devices has expanded, so has the demand for new and improved features of wireless communication devices.

As wireless communication devices have become more widely deployed, the number of communication systems available has also increased. Inefficiencies may arise when scanning for communication systems. Accordingly, systems and methods that may help to reduce these inefficiencies may be beneficial.

### BRIEF SUMMARY OF SOME EXAMPLES

Embodiments of the present invention address the above issues as well as others. Indeed, embodiments of the present invention provide power efficient devices, systems, and methods that can alleviate time delays. Doing so can not only utilize power resources efficiently but can aid in minimizing delays associated with network communications.

A method for wireless communication is described. The method includes performing a Better System Reselection (BSR) scan for systems. The method also includes finding a base system to camp on that is not a most preferred system. The method further includes determining whether to perform a recursive BSR scan starting from the base system found in the prior BSR scan.

The method may also include skipping, during the recursive BSR scan, any channels or frequency bands that were scanned in a prior BSR scan. The recursive BSR scan may include performing one or more BSR scans.

Each subsequent BSR scan may include building a new preferred system list that includes one or more systems that are more preferred than the base system of the prior BSR scan. Each subsequent BSR scan may also include scanning for the one or more systems included in the new preferred system list. Each subsequent BSR scan may further include updating the base system with a more preferred system found during the subsequent BSR scan.

The recursive BSR scan may further include stopping the recursive BSR scan when a preferred system list is exhausted or a most preferred system is found. The recursive BSR scan may additionally include camping on the best system available.

Determining that the base system is not a most preferred system may be based on a preferred roaming list (PRL). The method may also include determining whether a system identification (ID) of the base system is in a single geographic area or multiple geographic areas based on the PRL. If the system ID of the base system is in a single geographic area, then the method may include performing the recursive BSR scan using a new preferred system list. If the system ID of the base system is in multiple geographic areas, then the method may include performing a subsequent BSR scan using an existing preferred system list from the prior BSR scan. A most preferred system may be a system that is most preferred in a geographic area as defined by a PRL.

The method may also include comparing a system found during the recursive BSR scan to the base system to determine which system is more preferred.

An apparatus for wireless communication is also described. The apparatus includes a processor, memory in electronic communication with the processor and instructions stored in the memory. The instructions are executable by the processor to perform a BSR scan for systems. The instructions are also executable to find a base system to camp on that is not a most preferred system. The instructions are further executable to determine whether to perform a recursive BSR scan starting from the base system found in the prior BSR scan.

A wireless device is also described. The wireless device includes means for performing a BSR scan for systems. The wireless device also includes means for finding a base system to camp on that is not a most preferred system. The wireless device further includes means for determining whether to perform a recursive BSR scan starting from the base system found in the prior BSR scan.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments, it should be understood that such exemplary embodiments can be implemented in various devices, systems, and methods.

### BRIEF DESCRIPTION OF THE DRAWINGS

FIG. 1 is a block diagram illustrating a wireless communication device and one or more systems in which systems and methods for performing better system reselection (BSR) may be implemented according to some embodiments;

FIG. 2 is a flow diagram of a method for performing BSR according to some embodiments;

FIG. 3 is a flow diagram of a method for determining whether to perform a recursive BSR scan or a non-recursive BSR scan according to some embodiments;

FIG. 4 is a flow diagram of a method for performing a recursive BSR scan according to some embodiments;

FIG. 5 is a flow diagram of a method for performing a non-recursive BSR scan according to some embodiments;

FIG. 6 is a block diagram illustrating one configuration of a wireless communication device in which systems and methods for performing BSR may be implemented according to some embodiments; and

FIG. 7 illustrates certain components that may be included within a wireless communication device according to some embodiments.

### DETAILED DESCRIPTION

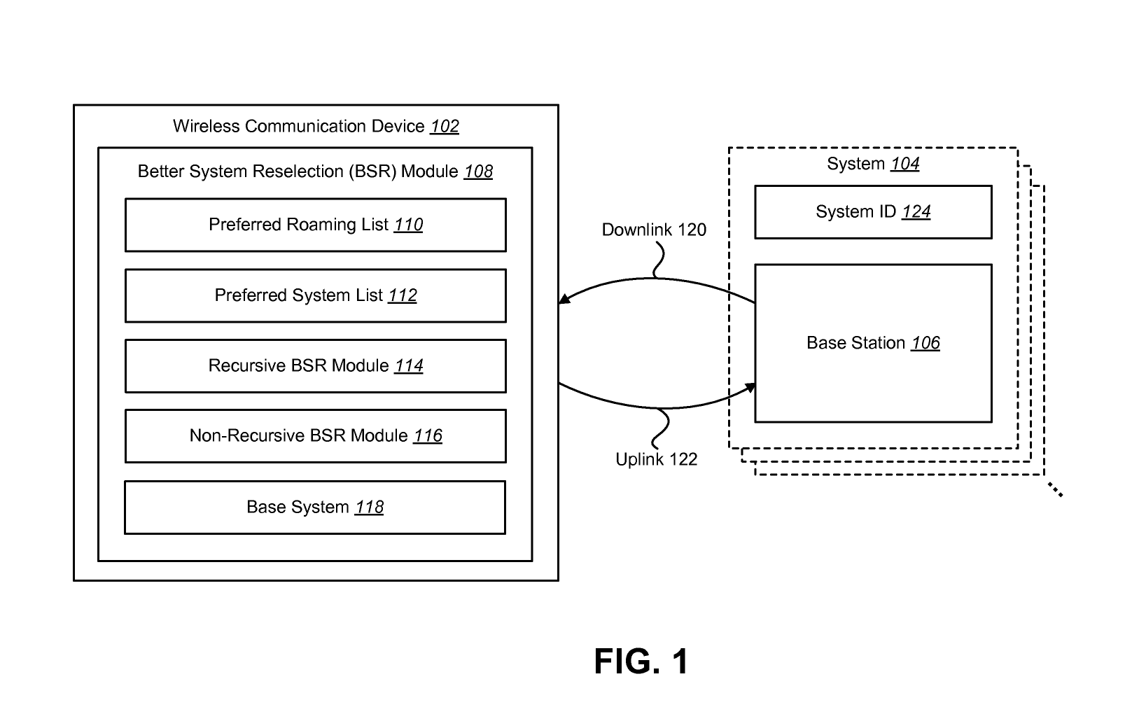

FIG. 1 is a block diagram illustrating a wireless communication device 102 and one or more systems 104 in which systems and methods for performing BSR may be implemented according to some embodiments. A system 104 may be a communication system that includes one or more base stations 106. A base station 106 is a device that may communicate with one or more wireless communication devices 102. A base station 106 may also be referred to as, and may include some or all of the functionality of, an access point, a broadcast transmitter, a NodeB, an evolved NodeB (eNB), etc. Each base station 106 may provide communication coverage for a particular geographic area (GEO). A base station 106 may provide communication coverage for one or more wireless communication devices 102. The term “cell” may refer to a base station 106 and/or its coverage area depending on the context in which the term is used. Examples of the base station 106 include cellular phone base stations, access points, etc.

The wireless communication device 102 may also be referred to as, and may include some or all of the functionality of, a terminal, an access terminal, a subscriber unit, a station, a user equipment (UE), etc. Examples of the wireless communication device 102 may include a cellular phone, a personal digital assistant (PDA), a wireless device, a wireless modem, a handheld device, a laptop computer, a session initiation protocol (SIP) phone, a wireless local loop (WLL) station, entertainment device, appliance, business/household device, visual display, automotive/vehicle component, sensor, actuator, solar array, etc.

A wireless communication device 102, system 104 and base station 106 may operate in accordance with certain industry standards, such as Third Generation Partnership Project (3GPP) Long Term Evolution (LTE) standards. Other examples of standards that a communication device may comply with include Institute of Electrical and Electronics Engineers (IEEE) 802.11a, 802.11b, 802.11g, 802.11n and/or 802.11ac (e.g., Wireless Fidelity or “Wi-Fi”) standards, IEEE 802.16 (e.g., Worldwide Interoperability for Microwave Access or “WiMAX”) standards, Code Division Multiple Access (CDMA) 2000 1x (referred to herein as “1x”, may also be referred to as IS-2000 or 1xRTT) standards, Evolution-Data Optimized (EVDO) standards, Interim Standard 95 (IS-95), High Rate Packet Data (HRPD), evolved High Rate Packet Data (eHRPD) radio standards and others. While some of the systems and methods disclosed herein may be described in terms of one or more standards, this should not limit the scope of the disclosure, as the systems and methods may be applicable to many systems and/or standards.

The terms “networks” and “systems” are often used interchangeably. A CDMA network may implement a radio access technology (RAT) such as Universal Terrestrial Radio Access (UTRA), CDMA2000, etc. UTRA includes W-CDMA and Low Chip Rate (LCR) while CDMA2000 covers IS-2000, IS-95 and IS-856 standards. A TDMA network may implement a radio access technology (RAT) such as Global System for Mobile Communications (GSM). An orthogonal frequency division multiple access (OFDMA) network may implement a radio access technology (RAT) such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). Additionally, CDMA2000 is described in documents from an organization named “3rd Generation Partnership Project 2” (3GPP2).

As used herein, the term “system” may refer to a communication system, a telecommunication system, a mobile telecommunication system, a network, a communication network, etc. Additionally, as used herein, the term “system” may refer to a radio access technology (RAT) that may be implemented within a particular system 104.

A wireless communication device 102 may communicate with one or more base stations 106 on a downlink 120 and/or an uplink 122 at any given moment. The downlink 120 (or forward link) refers to the communication link from a base station 106 to a wireless communication device 102, and the uplink 122 (or reverse link) refers to the communication link from a wireless communication device 102 to a base station 106.

A wireless communication device 102 may be capable of communicating with the one or more base stations 106 as part of one or more communication systems 104. A system 104 may utilize one or more radio access technologies (RATs). Examples of radio access technologies (RATs) include CDMA2000 1x (also known as 1x), Global System for Mobile Communications (GSM), High Data Rate (HDR), High Rate Packet Data (HRPD), evolved High Rate Packet Data (eHRPD), Wideband Code Division Multiple Access (W-CDMA) and Long Term Evolution (LTE). One or more of the systems 104 may utilize different types of radio access technologies (RATs). For example, a first system 104 may utilize a radio access technology (RAT) that may include a CDMA2000 1x network. In this example, a second system 104 may utilize a radio access technology (RAT) that may include a Long Term Evolution (LTE) network.

Communications between the wireless communication device 102 and base station 106 may be achieved through transmissions over a wireless link. Such a communication link may be established via a single-input and single-output (SISO), multiple-input and single-output (MISO) or a multiple-input and multiple-output (MIMO) system. A multiple-input and multiple-output system includes transmitter(s) and receiver(s) equipped, respectively, with multiple (N_{T}) transmit antennas and multiple (N_{R}) receive antennas for data transmission. Single-input and single-output and multiple-input and single-output systems are particular instances of a multiple-input and multiple-output system. The multiple-input and multiple-output system can provide improved performance (e.g., higher throughput, greater capacity or improved reliability) if the additional dimensionalities created by the multiple transmit and receive antennas are utilized.

Better System Reselection (BSR) appreciates that one cell (e.g., system 104) may be preferred over another, as determined by a carrier. In some scenarios, a wireless communication device 102 may perform a BSR scan to find and camp on (e.g., connect with) a more preferred system 104 as indicated by the carrier. For example, the wireless communication device 102 may be camped on a less preferred system 104, which may be a roaming system 104. The wireless communication device 102 may then perform a BSR scan to find more preferred systems 104.

In the current approach to BSR, a wireless communication device 102 may not camp on the most preferred system 104 currently available. This may occur because the wireless communication device 102 may end an immediate BSR phase when it finds a system 104 more preferred than the system 104 that was initially found (e.g., the system 104 that triggered the immediate BSR).

A system 104 may be identified by a system identification (ID) 124. In one configuration, the system ID 124 may be a Public Land Mobile Network (PLMN) number or ID. For example, the system ID 124 for a GSM/LTE system 104 may be a PLMN ID. In another configuration, the system ID 124 may be a combination of a system identifier (SID) and a network identifier (NID). For example, the system ID 124 for a CDMA system 104 (e.g., a 1x system) may be a SID/NID pair.

In one example, a geographic area (GEO) may have four systems 104. In this example, a first system 104 is represented by PLMN1 and includes two bands X and Y (e.g., PLMN1 (Band X, Y)). A second system 104 is represented by SID1/NID1 and includes channel 1 and channel 2 (e.g., S1/N1 (channel 1, 2). A third system 104 is represented by PLMN2 and includes one band X (e.g., PLMN2 (Band X)). The fourth system 104 is represented by SID2/NID1 and includes channel 3 (e.g., S2/N1 (channel 3). The geographic area has the following priority: PLMN 1 (Band X, Y)>S1/N1 (channel 1, 2)>PLMN2 (Band X)>S2/N1 (channel 3).

In this example, the wireless communication device 102 operating according to the current BSR approach may first find the fourth system 104 (e.g., S2/N1). The wireless communication device 102 triggers an immediate BSR on band X, Y (the bands of the most preferred system 104). In this case, band Y is not available, but band X is available. The wireless communication device 102 finds the third system 104 (e.g., PLMN2) during this scan but not PLMN1. According to the current approach, the wireless communication device 102 will camp on PLMN2 without checking to see if S1/N1 is available. Therefore, the wireless communication device 102 does not camp on the most preferred system 104 available.

This problem may be even greater when the system ID 124 (e.g., channel/band) of a system 104 is included in multiple geographic areas. As used herein, a multi-GEO match occurs when a system ID 124 is included in multiple geographic areas. A single-GEO match occurs when a system ID 124 is included in a single geographic area.

Because the wireless communication device 102 camps on a less preferred system 104 in the current approach, the wireless communication device 102 may be camped on a roaming system that is outside the home carrier. In some cases, this may result in additional expenses and/or reduced performance for the wireless communication device 102. Further, if the wireless communication device 102 receives a data call while camped on a cell, the wireless communication device 102 may not initiate a BSR scan for the duration of the data call. The wireless communication device 102 may remain camped on a less preferred system 104 for a long period of time before performing another BSR scan.

In one embodiment, the wireless communication device 102 may include a BSR module 108. The BSR module 108 may include a recursive BSR module 114 and/or a non-recursive BSR module 116. As used herein, the term “module” may indicate that a particular element may be implemented in hardware, software, firmware or any combination thereof. For example, the BSR module 108 may be implemented in hardware (e.g., circuitry), software or a combination of both. It should also be noted that one or more of the elements illustrated in FIG. 1 may be implemented in circuitry (e.g., integrated circuitry) in some configurations. Also in some scenarios, the BSR module 108 (and its internal components) can be implemented in various types of processors (ASIC, FPGAs) as a control unit with partitioned memory. In other arrangements, the BSR module 108 could be a configuration of switches or one or more state machines configured to change states based on parameters as discussed herein.

The wireless communication device 102 may perform a BSR scan based on a preferred roaming list (PRL) 110. In one scenario, a PRL may be programmed in the memory of a wireless communication device 102. In this scenario, the PRL may be programmed by a carrier.

In one embodiment, the PRL 110 may indicate one or more systems 104 that may be scanned and the order of preference of the systems 104. The PRL 110 may be built by a network operator (e.g., carrier) and may be provided to the wireless communication device 102. The PRL 110 may be used to identify home systems 104 and roaming systems 104. The wireless communication device 102 may use the PRL 110 to choose systems 104 that are more preferred, as determined by the carrier who provided the PRL 110. For example, if the wireless communication device 102 is outside the home system 104, then the wireless communication device 102 may choose to connect to (e.g., camp on) a system 104 with whom the home carrier has a cost-saving roaming agreement, rather than using non-affiliated carriers.

The PRL 110 may identify systems 104 by their frequencies (e.g., channels and/or bands). As used herein, a “band” is a range of radio communication frequencies. A “channel” is one or more codes that may be used to encode/decode one or more signals in a band. For example, when multiple signals are encoded and transmitted through a certain band, a receiver may use different codes (e.g., channel) to decode the signals in that band. The term “frequency” will be used herein to refer to a channel and/or a band associated with a system 104.

The PRL 110 may prioritize systems 104 that the wireless communication device 102 may search for (e.g., scan). Prioritization may be programmed in the PRL 110 by a carrier. For example, a PRL 110 may indicate that a system-A is more-preferred than a system-B, and so on. There may also be other rules to determine the priority. The ordering may be based on system IDs 124 (e.g., PLMN-ID and/or SID/NID) included in the PRL 110.

The PRL 110 may group systems 104 according to geographic areas (GEOs). The PRL 110 may include one or more GEOs. The GEOs may be arranged in order of preference. A system 104 may be included in one or more GEOs. Systems 104 may be arranged in order of preference within each GEO. Systems 104 in different GEOs may have the same frequency (e.g., channel/band). In other words, each system 104 may have a system ID 124 and a frequency (e.g., channel/band) associated with it. In some scenarios, different system IDs 124 may have the same frequency. For example, if systems 104 are in different GEOs, then the systems 104 may have different system IDs 124 but the same frequency.

The BSR module 108 may acquire a system 104. For example, the BSR module 108 may acquire a system 104 during startup (e.g., during an out-of-service scan). The BSR module 108 may also acquire a system 104 by performing a periodic BSR scan. In some configurations, a periodic BSR scan may occur upon expiration of a periodic BSR timer. For example, the wireless communication device 102 may find a system 104 included in the PRL 110 and may camp on that system. The wireless communication device 102 may move to an area where a more preferred system 104 is located. The wireless communication device 102 may perform a periodic BSR scan and may discover the more preferred system 104 by scanning the channel/band associated with the more preferred system 104.

Upon acquiring a system 104, the BSR module 108 may perform an immediate BSR scan to find a system 104 to camp on that is more preferred than the acquired system 104. The BSR scan may be performed based on a preferred system list 112. In one embodiment, the preferred system list 112 may include one or more systems 104 that are more preferred than the acquired system 104. The BSR module 108 may build the preferred system list 112 using the PRL 110.

In one configuration, the preferred system list 112 may include the frequencies of each system 104 that is more preferred than the acquired system 104. The frequencies may be listed in the order of preference of the system 104 associated with the frequency, as indicated by the PRL 110. For example, the frequencies included in the preferred system list 112 may be ranked from most preferred system 104 to least preferred system 104. If multiple GEOs are included in the PRL 110, then the frequencies may be listed in the preferred system list 112 starting with the most preferred GEO to the least preferred GEO. It should be noted only one instance of a particular frequency is included in the preferred system list 112. If two systems 104 in the PRL 110 have the same frequency (e.g., channel/band), then the frequency is only included once in the preferred system list 112. Therefore, the preferred system list 112 avoids duplicate frequencies.

The BSR module 108 may perform a BSR scan for systems 104 using the preferred system list 112. Starting with the most preferred system 104, the BSR module 108 may scan the frequency (e.g., channel/band) associated with the system 104 to determine if the system 104 is available. If a system 104 is not available (e.g., the scan of the channel/band fails), then the next frequency in the preferred system list 112 may be scanned.

The BSR module 108 may find a base system 118 to camp on that is not a most preferred system 104. The base system 118 may be a system 104 that is found as a result of a BSR scan. The base system 118 may become the starting system 104 for a subsequent BSR scan. The BSR module 108 may store the base system 118 and the channel/band associated with the base system 118 as the more preferred (e.g., best) system 104 found so far.

The BSR module 108 may determine that the base system 118 is not a most preferred system based on the PRL 110. As used herein, a “most preferred” system 104 is a system 104 that has the greatest preference in a GEO, as indicated by the PRL 110. For example, the BSR module 108 may check the PRL 110 to determine whether the base system 118 is the first system 104 listed for any GEO. If the base system 118 is a most preferred system 104, then the wireless communication device 102 may camp on that base system 118. However, if the BSR module 108 determines that the base system 118 is not a most preferred system 104, then the BSR module 108 may continue to search for more preferred systems 104.

In one embodiment, the BSR module 108 may determine whether the base system 118 is in a single GEO or in multiple GEOs. This may be accomplished based on the PRL 110. For example, the BSR module 108 may check the PRL 110 to see if the system ID 124 of the base system 118 is listed in a single GEO or in multiple GEOs. If the BSR module 108 determines that the base system 118 is in a single GEO (e.g., a single-GEO match), then a recursive BSR module 114 may perform a recursive BSR scan. However, if the BSR module 108 determines that the system ID 124 of the base system 118 is in multiple GEOs (e.g., a multi-GEO match), then a non-recursive BSR module 116 may perform a non-recursive BSR scan.

A recursive BSR scan may be performed starting from the base system 118 found in the prior BSR scan. As used herein, “recursive” means performing an action until stop criteria are met. During the recursive BSR scan, any frequency (e.g., channels or frequency bands) that was scanned during the current BSR scan cycle may be skipped. A BSR scan cycle includes an initial BSR scan and subsequent recursive BSR scans that may be performed until the wireless communication device 102 camps on a system 104. A frequency may be skipped during a recursive BSR scan because a prior BSR scan failed to find those channels/bands. During the recursive BSR scan, higher priority systems 104 may be scanned before scanning for lower priority systems. Furthermore, the wireless communication device 102 should always camp on the most preferred system available. This may not occur in the case of a registered PLMN (RPLMN) in 3GPP systems.

The recursive BSR module 114 may build a new preferred system list 112 that includes the frequencies of one or more systems 104 that are more preferred than the base system 118. For example, the new preferred system list 112 may include the frequencies of each system 104 in the GEO of the base system 118 that is more preferred than the base system 118. The recursive BSR module 114 may then perform a BSR scan using the new preferred system list 112.

If a more preferred system 104 than the base system 118 is found, the recursive BSR module 114 may update the base system 118 with the more preferred system 104 found during the recursive BSR scan. The recursive BSR module 114 may store the channel (and/or band) on which the base system 118 was found. The recursive BSR module 114 may determine if the new base system 118 is a most preferred system 104, based on the PRL 110. If the new base system 118 is a most preferred system 104, then the wireless communication device 102 may camp on the base system 118.

If the new base system 118 is not a most preferred system 104, then the recursive BSR module 114 may perform another recursive BSR scan, starting with the new base system 118. If the new base system 118 is in a single GEO, the recursive BSR module 114 will build a new preferred system list 112 that includes un-scanned frequencies of systems 104 that are more preferred than the new base system 118 and perform a BSR scan of the frequencies included in the new preferred system list 112. The recursive BSR module 114 may continue this process until a most preferred system 104 is found or the preferred system list 112 is exhausted.

The non-recursive BSR module 116 may perform a non-recursive BSR scan using the existing preferred system list 112 from the prior BSR scan. In this case, because the system ID 124 of the base system 118 is included in multiple GEOs, the non-recursive BSR module 116 does not know which GEO the base system 118 belongs to. Therefore, the non-recursive BSR module 116 may continue scanning systems 104 in the existing preferred system list 112, skipping channels/bands that have already been scanned. In other words, because this is a multi-GEO match, the wireless communication device 102 cannot identify which GEO the system 104 belongs to and continues to search for systems 104 with the existing preferred system list 112.

The non-recursive BSR module 116 may compare a system 104 found during the subsequent BSR scan to the base system 118 to determine which system 118 is more preferred. If a more preferred system 104 than the base system 118 is found, the non-recursive BSR module 116 may update the base system 118 with the more preferred system 104 found during the subsequent BSR scan. The non-recursive BSR module 116 may store the channel (and/or band) on which the base system 118 was found. The wireless communication device 102 may then camp on the base system 118.

A recursive or non-recursive BSR scan may be stopped if the preferred system list 112 is exhausted or if a most preferred system 104 is found. Therefore, if either the recursive BSR module 114 or the non-recursive BSR module 116 determines that each system 104 (e.g., frequency) in the preferred system list 112 has been scanned during a prior BSR scan or subsequent BSR scans, then the wireless communication device 102 may camp on the system 104 that is currently the base system 118 (e.g., the best system 104 found). If either the recursive BSR module 114 or the non-recursive BSR module 116 finds the most preferred system 104 in a GEO, then the wireless communication device 102 may camp on that most preferred system 104.

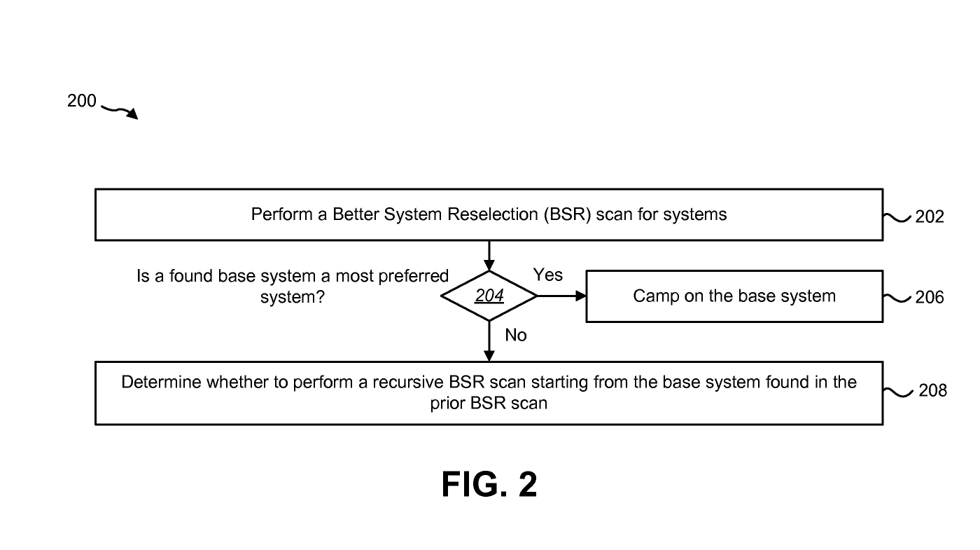

FIG. 2 is a flow diagram of a method 200 for performing BSR according to some embodiments. The method 200 may be performed by a wireless communication device 102. For example, the method 200 may be performed by a BSR module 108. The wireless communication device 102 may perform 202 a better system reselection (BSR) scan for systems 104. After acquiring a system 104, the wireless communication device 102 may perform 202 a BSR scan for more preferred systems 104 to camp on. The BSR scan may be an immediate BSR scan.

The wireless communication device 102 may perform 202 the BSR scan based on a preferred system list 112. In one embodiment, the preferred system list 112 may include one or more systems 104 that are more preferred than the acquired system 104. The wireless communication device 102 may build the preferred system list 112 using a PRL 110. The preferred system list 112 may include the frequency of each system 104 that is more preferred than acquired system 104. This may be accomplished as described in connection with FIG. 1. Starting with the most preferred system 104, the wireless communication device 102 may scan the frequency (e.g., channel/band) associated with the system 104 to determine if the system 104 is available. If the system 104 is not available (e.g., the scan of the channel/band fails), then the next system 104 in the preferred system list 112 may be scanned.

The wireless communication device 102 may determine 204 whether a found base system 118 is a most preferred system 104. A base system 118 may be a system 104 that is found as a result of a BSR scan. The wireless communication device 102 may store the base system 118 and the channel/band associated with the base system 118. The wireless communication device 102 may determine 204 whether a found base system 118 is a most preferred system 104 based on a preferred roaming list (PRL) 110 stored on the wireless communication device 102. If the found base system 118 is a most preferred system 104, then the wireless communication device 102 may camp 206 on the base system 118.

If the wireless communication device 102 may determines 204 that a found base system 118 is not a most preferred system, then the wireless communication device 102 may determine 208 whether to perform a recursive BSR scan starting from the base system 118 found in the prior BSR scan. The base system 118 may become the starting system 104 for a subsequent BSR scan. The wireless communication device 102 may store the base system 118 and the channel/band associated with the base system 118 as the more preferred (e.g., best) system 104 found so far. The wireless communication device 102 may determine that the base system 118 is not a most preferred system based on the PRL 110.

In one embodiment, the wireless communication device 102 may determine whether the system ID 124 of the base system 118 is in a single GEO or in multiple GEOs. This may be accomplished based on the PRL 110. For example, the wireless communication device 102 may check the PRL 110 to see if the system ID 124 of the base system 118 is listed in a single GEO or in multiple GEOs.

If the wireless communication device 102 determines that the system ID 124 of the base system 118 is in a single GEO, then the wireless communication device 102 may perform a recursive BSR scan. However, if the wireless communication device 102 determines that the system ID 124 of the base system 118 is in multiple GEOs, then the wireless communication device 102 may perform a non-recursive BSR scan.

During a recursive BSR scan, the wireless communication device 102 may build a new preferred system list 112 that includes one or more systems 104 that are more preferred than the base system 118. For example, the wireless communication device 102 may include each system 104 in the GEO of the base system 118 that is more preferred than the base system 118. The wireless communication device 102 may then perform a recursive BSR scan using the new preferred system list 112. If a more preferred system 104 than the base system 118 is found, the wireless communication device 102 may update the base system 118 with the more preferred system 104. The wireless communication device 102 may store the frequency (e.g., channel and/or band) on which the base system 118 was found. During a recursive BSR scan, any channels or frequency bands that were scanned in the prior BSR scan may be skipped.

The wireless communication device 102 may determine whether the updated base system 118 is a most preferred system 104 in a GEO. If the updated base system 118 is a most preferred system 104 in a GEO, then the wireless communication device 102 may camp on the updated base system 118. If the updated base system 118 is not a most preferred system 104 in a GEO, then the wireless communication device 102 may perform another BSR scan, starting with the updated base system 118. For example, the wireless communication device 102 may build a new preferred system list 112 that includes one or more systems 104 that are more preferred than the updated base system 118. The wireless communication device 102 may then perform a BSR scan using the updated preferred system list 112. It should be noted that the wireless communication device 102 may continue looping into smaller and smaller preferred system lists 112 until the wireless communication device 102 finds the best available system 104 as indicated by the PRL 110.

When initiating a recursive BSR scan, the wireless communication device 102 may determine whether a base system 118 and any updated base system 118 have a single-GEO match or a multi-GEO match. If the base system 118 or an updated base systems 118 have a single-GEO match (e.g., the system ID 124 is included in one GEO), then the wireless communication device 102 may perform a recursive BSR scan. However, if the base system 118 or an updated base systems 118 have a multi-GEO match (e.g., the system ID 124 is included in multiple GEOs), then to avoid the inefficiency of looping from one GEO to another, the wireless communication device 102 may perform a non-recursive BSR scan.

For a non-recursive BSR scan, the wireless communication device 102 may perform a subsequent BSR scan using the existing preferred system list 112 from the prior BSR scan. The wireless communication device 102 may continue scanning systems 104 in the existing preferred system list 112, skipping channels/bands that have already been scanned.

The wireless communication device 102 may compare a system 104 found during the subsequent BSR scan to the base system 118 to determine which system 118 is more preferred. If a more preferred system 104 than the base system 118 is found, the wireless communication device 102 may update the base system 118 with the more preferred system 104 found during the subsequent BSR scan.

With both recursive BSR scanning and non-recursive BSR scanning, a BSR scan may be stopped if the preferred system list 112 is exhausted or if a most preferred system 104 is found. Therefore, if the wireless communication device 102 determines that each system 104 in the preferred system list 112 has been scanned, then the wireless communication device 102 may camp on the system 104 that is currently the base system 118. If the wireless communication device 102 finds a system 104 during a BSR scan that is a most preferred system 104 in a GEO, then the wireless communication device 102 may camp on that most preferred system 104.

The systems and methods described herein may provide a faster acquisition time of a home system 104. Furthermore, the wireless communication device 102 may camp on the best available system 104.

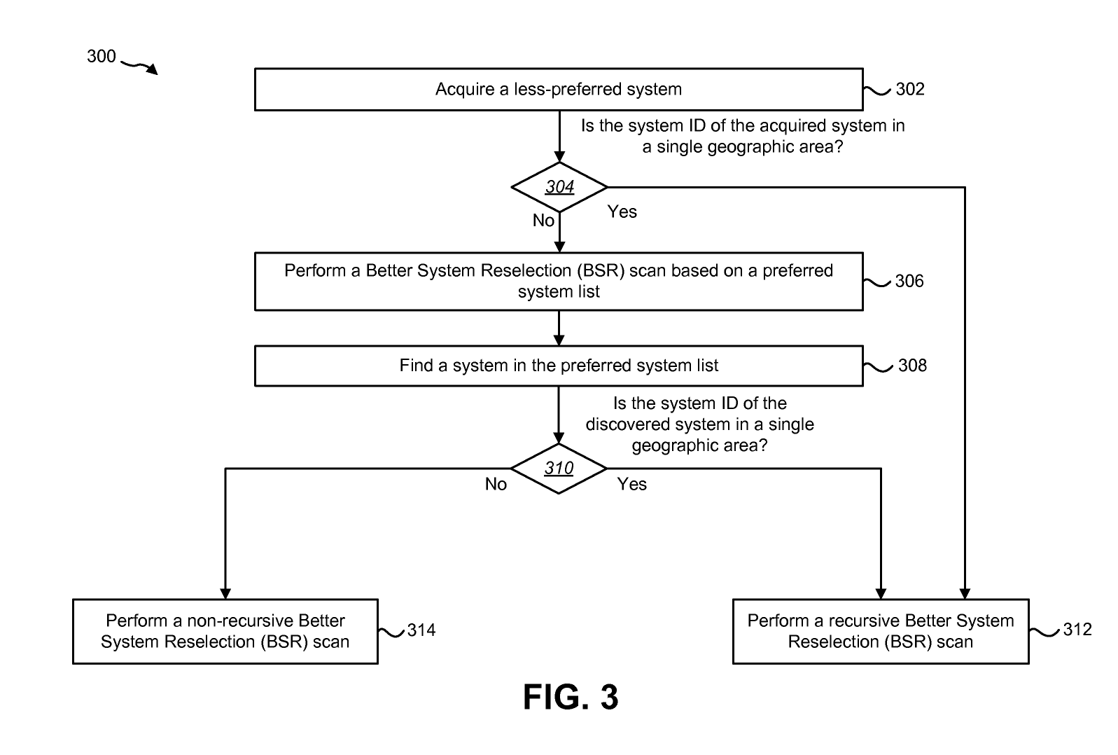

FIG. 3 is a flow diagram of a method 300 for determining whether to perform a recursive BSR scan or a non-recursive BSR scan according to some embodiments. The method 300 may be performed by a wireless communication device 102. For example, the method 300 may be performed by a BSR module 108. The wireless communication device 102 may acquire 302 a less-preferred system 104. The system 104 may be a communication system or network as described above in connection with FIG. 1. The wireless communication device 102 may acquire 302 the system 104 by performing a scan. For example, the wireless communication device 102 may perform an out-of-service (00S) scan or a BSR scan. The system 104 may be less-preferred as indicated by a preferred roaming list (PRL) 110.

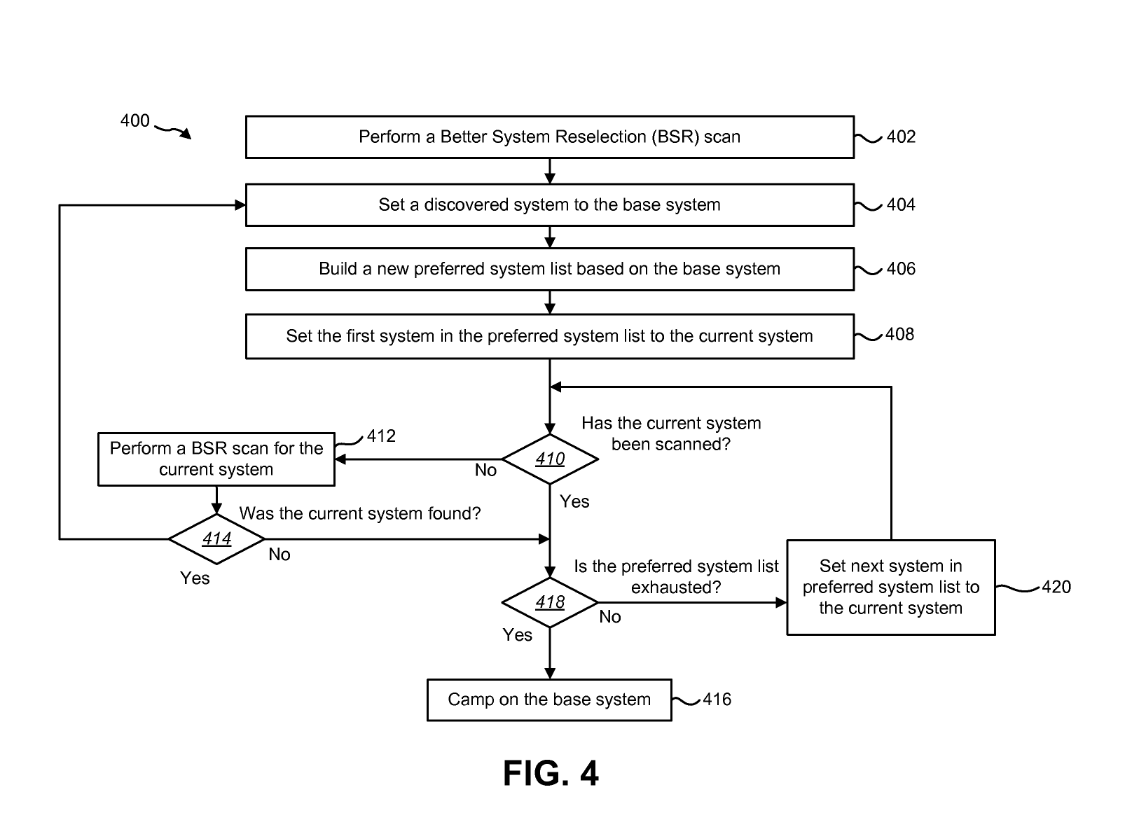

Upon acquiring 302 the less-preferred system 104, the wireless communication device 102 may determine 304 whether the system ID 124 of the acquired system 104 is in a single geographic area (GEO). When the wireless communication device 102 finds a system 104, the wireless communication device 102 will determine 304 if the system 104 allows the wireless communication device 102 to enter a single-GEO match. In other words, the wireless communication device 102 will determine 304 whether the system ID 124 of the system 104 is in a single GEO. This may be accomplished by checking a PRL 110 to see if the system ID 124 of the acquired system 104 is included in a single GEO or multiple GEOs. If the system ID 124 of the acquired system 104 is in a single GEO, the wireless communication device 102 may perform a recursive BSR scan 314. The recursive BSR scan is described below in connection with FIG. 4.

If the wireless communication device 102 determines 304 that the system ID 124 of the acquired system 104 is not in a single GEO (e.g., the system ID 124 of the acquired system 104 is in multiple GEOs), then the wireless communication device 102 may perform 306 a BSR scan based on a preferred system list 112. The wireless communication device 102 may build the preferred system list 112 by including systems 104 that are more preferred than the acquired system 104, as indicated by the PRL 110. This may be accomplished as described in connection with FIG. 1.

The wireless communication device 102 may find 308 a system 104 in the preferred system list 112. The wireless communication device 102 may set this discovered system 104 as the base system 118 for a subsequent BSR scan.

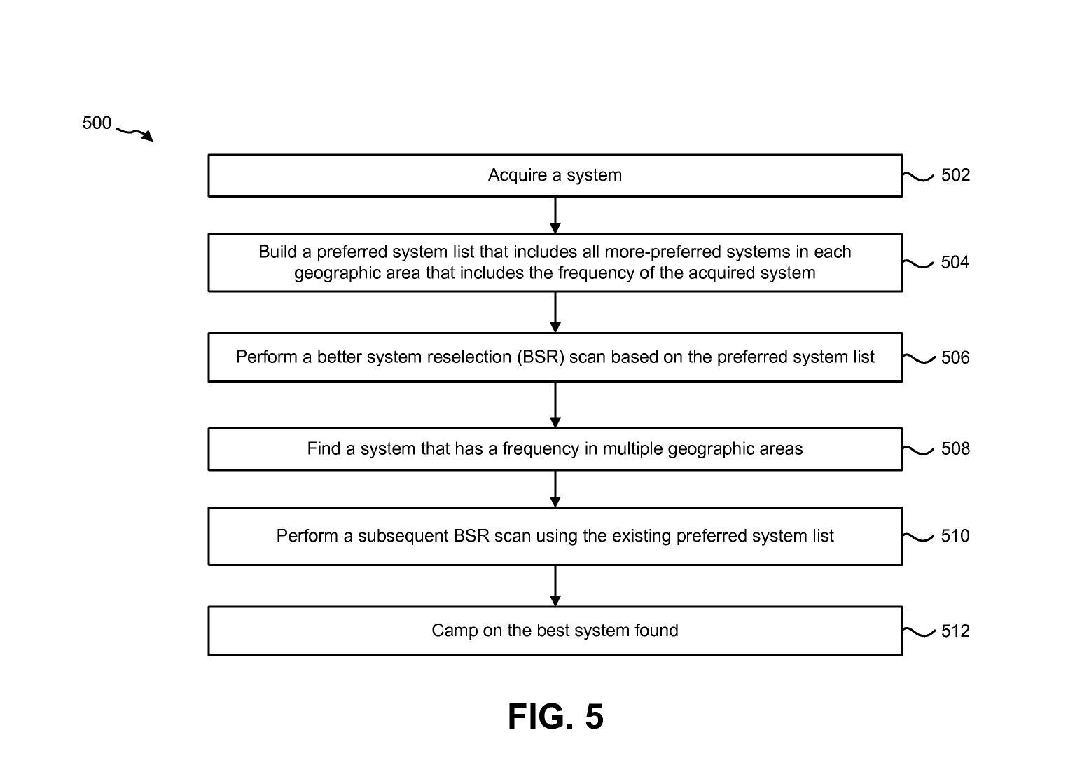

The wireless communication device 102 may determine 310 whether the system ID 124 of the discovered system 104 (e.g., base system 118) is in a single GEO. In other words, the wireless communication device 102 may determine 310 if the system 104 allows the wireless communication device 102 to enter a single-GEO match. If the system ID 124 of the discovered system 104 is in a single GEO, then the wireless communication device 102 may perform 312 a recursive BSR scan. If the system ID 124 of the discovered system 104 is not in a single GEO (e.g., the system ID 124 of the base system 118 is in multiple GEOs), then the wireless communication device 102 may perform 314 a non-recursive BSR scan, as described below in connection with FIG. 5.

The described method 300 may be summarized according to the following pseudo code of Listing (1).

Listing (1)

```
If a system 104 is multi-GEO matched:
  1. If currently in a multi-GEO match and moving to single-GEO match:
        Then perform recursive BSR:
            Update the current base system 118 (best-found-so-far)
            Update the preferred system list 112 to include all systems
                  in the GEO that are more preferred than the
                  base system 118
  2. If currently in a multi-GEO match and moving to a multi-GEO
    match, OR currently in a single-GEO match and moving to a
    multi-GEO match:
        Then perform a non-recursive BSR:
            Update the current base system 118 (best-found-so-far)
            Continue on the existing preferred system list 112
  If a system 104 is single-GEO matched:
      Always perform a recursive BSR scan:
        Update the current base system 118 (best-found-so-far)
        Update the preferred system list 112 to include all systems in
            the GEO that are more preferred than the
            base system 118
  STOP Conditions:
      a. If the preferred system list 112 is exhausted
      b. If the most preferred system 104 is found
  Scanning Condition:
      During the current BSR phase (e.g., immediate/recursive
        BSR scan or immediate/non-recursive scan), a channel
        should only be scanned once
```

FIG. 4 is a flow diagram of a method 400 for performing a recursive BSR scan according to some embodiments. The method 400 may be performed by a wireless communication device 102. The wireless communication device 102 may perform 402 a first BSR scan. The first BSR scan may be performed 402 upon acquiring a system 104. For example, the wireless communication device 102 may acquire a system 104 during startup (e.g., during an out-of-service scan) or upon expiration of a periodic BSR timer (e.g., during a periodic BSR scan).

The wireless communication device 102 may perform 402 the first BSR scan based on a preferred system list 112. The preferred system list 112 may include one or more systems 104 that are more preferred than the acquired system 104. The wireless communication device 102 may scan for systems 104 using the preferred system list 112. The wireless communication device 102 may scan more preferred systems 104 before scanning less preferred systems 104.

The wireless communication device 102 may set 404 a discovered system 104 to the base system 118. The base system 118 may be a system 104 that is found as a result of the prior BSR scan. The base system 118 may become the starting system 104 for a subsequent BSR scan. When the wireless communication device 102 finds a system 104, the wireless communication device 102 will determine if the system 104 allows the wireless communication device 102 to enter a single-GEO match. In this case, the system ID 124 of the base system 118 is in a single GEO, therefore, the wireless communication device 102 enters a single-GEO match.

In one embodiment, the wireless communication device 102 may store two variables associated with the base system 118. The variable Current_Pref_Sys may indicate the most preferred system that has been found. The variable Current_Pref_Chnl may indicate the channel/band on which the Current_Pref_Sys was found. If the wireless communication device 102 discovers a system 104 during scanning, the wireless communication device 102 may update the Current_Pref_Sys and the Current_Pref_Chnl to the more preferred system 104.

The wireless communication device 102 may build 406 a new preferred system list 112 based on the base system 118. Because the system ID 124 of the base system 118 is in a single GEO, the new preferred system list 112 includes only those systems 104 from the GEO of the base system 118 that are more preferred than the base system 118.

The wireless communication device 102 may set 408 the first system 104 in the preferred system list 112 to the current system 104. The current system 104 may be a variable that is stored in the wireless communication device 102 that is used during a recursive BSR scan.

The wireless communication device 102 may determine 410 whether the current system 104 has been scanned. For example, the wireless communication device 102 may determine whether the channel/band of the current system 104 was scanned in the first BSR scan. If the current system 104 has not been scanned, then the wireless communication device 102 may perform 412 a BSR scan for the current system 104. This may be accomplished by scanning the channel and/or band associated with the current system 104.

If the wireless communication device 102 determines 414 that the current system 104 was found (e.g., the channel/band was acquired), then the wireless communication device 102 may set 404 the current system 104 to be the base system 118. In other words, the wireless communication device 102 may update the base system 118 with a more preferred system found during a BSR scan. The wireless communication device 102 may then repeat the recursive BSR scan procedure starting with the updated base system 118.

If the wireless communication device 102 determines 410 that the current system 104 was scanned, then the wireless communication device 102 may skip scanning the current system 104. In one embodiment, this may be accomplished by adding the current system 104 to a blacklist if the current system 104 has been scanned.

The wireless communication device 102 may determine 418 if the preferred system list 112 is exhausted. The wireless communication device 102 may determine 418 whether each system 104 included in the preferred system list 112 has been scanned. The systems 104 may be scanned in either the first BSR scan or a subsequent BSR scan.

If the wireless communication device 102 determines 418 that the preferred system list 112 is not exhausted, then the wireless communication device 102 may set 420 the next system 104 in the preferred system list 112 to the current system 104. The next system 104 is the next most preferred system 104 after the current system 104. The wireless communication device 102 may then determine 410 whether the updated current system 104 has been scanned.

If the wireless communication device 102 determines 418 that the preferred system list 112 is exhausted (e.g., each system 104 in the preferred system list 112 has been scanned), then the wireless communication device 102 may camp 416 on the base system 118. It should be noted that the system 104 that was used to find the GEO in which the wireless communication device 102 is located may not be more preferred than the final base system 118 that is found (e.g., the Current_Pref_Sys).

Examples of recursive BSR according to the described systems and methods are provided in Tables (1)-(3). In a first scenario included in Table (1), the recursive BSR scan results in a more preferred system 104 being discovered.

TABLE (1)
Scenario #1:

Given:

GEO-1 = { s1(750), s2(100), s3(450), s4(225, 250, 275),
s5(LTE.B13) }
GEO-2 = { s6(758), s7(100), s8(450), s5(LTE.B13) }
GEO-3 = { s9(525), s5(LTE.B13) }

Scenario:

| | |
|---|---|
| • | The wireless communication device 102 is located in GEO-2 |
| • | Power up and acquire the s5 LTE system, which matches |
| | wildcard MCC = 311, MNC = 0XFFF |
| • | Channel 450 and Channel 758 are available |

Legacy Behavior:

| | |
|---|---|
| 1) | Acquire s5 (LTE) system |
| 2) | Build PREF_LIST contains: |
| | { s1(750), s2(100), s3(450), s4(225, 250, 275), s6(758), |
| | s9(525) } |
| | Note that s7 and s8 contain the same band/channel as |
| | s2 and s3 |
| 3) | Attempt to scan channel: 750 → FAILED, 100 → FAILED |
| 4) | Scanned channel 450, and found s8 in GEO-2 |
| 5) | Camp on s8; Start periodic BSR |

New Behavior:

| | |
|---|---|
| 1) | Acquire s5 (LTE) system. s5 is a multi-GEO match |
| 2) | Build PREF_LIST that includes |
| | { s1(750), s2(100), s3(450), s4(225, 250, 275), s6(758), |
| | s9(525) } |
| | Note: s7 and s8 contain the same band/channel as s2 and s3 |
| 3) | Attempt to scan channel: 750 → FAILED, 100 → FAILED |
| 4) | Scanned channel 450, and found s8 in GEO-2 |
| | Note: s8 is a single-GEO match, and transitioning from multi- |
| | GEO match to a single GEO-match |
| 5) | Initiate recursive BSR to GEO-2: |
| | Build new PREF_LIST { s6(758), s7(100) } |
| | Update the best channel found to be channel 450 |
| 6) | Attempt to scan channel: 758 → ACQUIRE |
| 7) | Camp on s6 (channel 758) |

In Table (1), a system 104 and channel/band are indicated as sX(Y), where X is a system ID 124 (or number) and Y is the channel number. For example, s1 (750) represents system 1, channel 750. The systems 104 may be a 1x system, an LTE system or other radio access technology. The systems 104 are included in three GEOs (e.g., GEO-1, GEO-2 and GEO-3). This information may be provided in a PRL 110. It should be noted that each GEO has a common LTE system (e.g., s5 (LTE.B13)).

In this scenario, the wireless communication device 102 is located in GEO-2. Upon powering up, the wireless communication device 102 acquires the s5 LTE system. In this scenario, Channel 450 and Channel 758 are available.

Table (1) describes the legacy behavior for this scenario. Upon acquiring s5, the wireless communication device 102 would build a preferred system list 112 (e.g., PREF_LIST) that includes the more preferred systems 104 from each GEO that includes s5. The systems 104 are included in the preferred system list 112 based on order of preference. However, s7 and s8 are excluded because they contain the same channel/band as s2 and s3, respectively.

The wireless communication device 102 operating according to legacy behavior performs a BSR scan. The wireless communication device 102 attempts to scan channel 750 (e.g., s1) and channel 100 (e.g., s2), but these scans fail because these systems 104 are not available. However, the scan of channel 450 is successful for s8 in GEO-2. According to legacy behavior, the wireless communication device 102 then camps on s8 and starts a periodic BSR timer. However, s8 is not the more preferred system 104 in GEO-2. For example, s8 in GEO-2 could be a roaming system 104.

A wireless communication device 102 operating according to the described systems and methods may perform the new behavior of Table (1). The wireless communication device 102 may perform steps 1-4 as is done in the legacy behavior. However, upon finding s8 in step 4, the wireless communication device 102 determines that s8 is in a single-GEO match and transitioning from a multi-GEO match (s5). Therefore, the wireless communication device 102 initiates a recursive BSR scan for GEO-2.

The wireless communication device 102 builds a new preferred system list 112 that includes s6 and s7 (the systems 104 in GEO-2 that are more preferred than s8). The wireless communication device 102 also updates the best channel found (e.g., Current_Pref_Chnl) to be channel 450. The wireless communication device 102 then performs a recursive BSR scan. The wireless communication device 102 attempts to scan channel 758 (e.g., s6). Because channel 758 is available, the wireless communication device 102 acquires channel 758 on s6. The wireless communication device 102 then camps on s6. Therefore, by performing recursive BSR, the wireless communication device 102 found the most preferred system 104 in GEO-2.

In a second scenario included in Table (2), a recursive BSR scan is performed, but does not find a more preferred system 104.

TABLE (2)
Scenario #2:

Given:

GEO-1 = { s1(750), s2(100), s3(450), s4(225, 250, 275),
s5(LTE.B13) }
GEO-2 = { s6(758), s7(100), s8(450), s5(LTE.B13) }
GEO-3 = { s9(525), s5(LTE.B13) }

Scenario:

| | |
|---|---|
| • | The wireless communication device 102 is located in GEO-2 |
| • | Power up and acquire the s5 LTE system, which matches |
| | wildcard MCC = 311, MNC = 0XFFF |
| • | Channel 450 is available |

Legacy Behavior:

| | |
|---|---|
| 1) | Acquire s5 (LTE) system |
| 2) | Build PREF_LIST contains: |
| | { s1(750), s2(100), s3(450), s4(225, 250, 275), s6(758), |
| | s9(525) } |
| | Note that s7 and s8 contain the same band/channel as |
| | s2 and s3 |
| 3) | Attempt to scan channel: 750 → FAILED, 100 → FAILED |
| 4) | Scanned channel 450, and found s8 in GEO-2 |
| 5) | Camp on S8. Start periodic BSR. |

New Behavior:

| | |
|---|---|
| 1) | Acquire s5 (LTE) system. s5 is a multi-GEO match |
| 2) | Build PREF_LIST that includes |
| | { s1(750), s2(100), s3(450), s4(225, 250, 275), s6(758), |
| | s9(525) } |
| | Note: s7 and s8 contain the same band/channel as s2 and s3 |
| 3) | Attempt to scan channel: 750 → FAILED, 100 → FAILED |
| 4) | Scanned channel 450, and found s8 in GEO-2 |
| | Note: s8 is a single-GEO match, and transitioning from multi- |
| | GEO match to a single GEO-match |
| 5) | Initiate recursive BSR to GEO-2: |
| | Build new PREF_LIST { s6(758), s7(100) } |
| | Update the best channel found to be channel 450 |
| 6) | Attempt to scan channel: 758 → FAILED |
| | Note: Channel 100 is SKIPPED because it was scanned in |
| | step 3 |
| 7) | PREF_LIST has been exhausted |
| 8) | Come back and acquire the best channel found: Channel 450 |
| 9) | Camp on s8 (channel 450) |

In the scenario of Table (2) the conditions are the same as the scenario of Table (1), but now only channel 450 is available. The legacy behavior results in the wireless communication device 102 camping on s8.

A wireless communication device 102 operating according to the described systems and methods may perform the new behavior of Table (2). The wireless communication device 102 may perform steps 1-4 as is done in the legacy behavior. However, upon finding s8 in step 4, the wireless communication device 102 determines that s8 is in a single-GEO match and transitioning from a multi-GEO match (s5). Therefore, the wireless communication device 102 initiates a recursive BSR scan for GEO-2.

The wireless communication device 102 builds a new preferred system list 112 that includes s6 and s7 (the systems 104 in GEO-2 that are more preferred than s8). The wireless communication device 102 also updates the best channel found (e.g., Current_Pref_Chnl) to be channel 450. The wireless communication device 102 then performs a recursive BSR scan. The wireless communication device 102 attempts to scan channel 758 (e.g., s6), but because channel 758 is not available, the scan fails. The wireless communication device 102 skips scanning channel 100 (e.g., s7) because it was scanned in step 3. At this point, the wireless communication device 102 determines that the preferred system list 112 has been exhausted. The wireless communication device 102 then returns to the best channel found (e.g., Current_Pref_Chnl) and camps on s8.

In a third scenario included in Table (3), a recursive BSR scan is performed with an empty preferred system list 112.

TABLE (3)
Scenario #3:

Given:

GEO-1 = { s1(750), s2(100), s3(450), s4(225, 250, 275),
s5(LTE.B13) }
GEO-2 = { s7(100), s8(450), s5(LTE.B13) }
GEO-3 = { s9(525), s5(LTE.B13) }

Scenario:

| | |
|---|---|
| • | The wireless communication device 102 is located in GEO-2 |
| • | Power up and acquire the s5 LTE system, which matches |
| | wildcard MCC = 311, MNC = 0XFFF |
| • | Channel 450 is available |
| • | Note: s6 is not in GEO-2 |

Legacy Behavior:

| Same as scenario 1 | |
|---|---|
| 1) | Camp on S8. Start periodic BSR. |

New Behavior:

| | |
|---|---|
| 1) | Acquire s5 (LTE) system. s5 is a multi-GEO match |
| 2) | Build PREF_LIST that includes |
| | { s1(750), s2(100), s3(450), s4(225, 250, 275), s9(525) } |
| | Note: s7 and s8 contain the same band/channel as s2 and s3 |
| 3) | Attempt to scan channel: 750 → FAILED, 100 → FAILED |
| 4) | Scanned channel 450, and found s8 in GEO-2 |
| | Note: s8 is a single-GEO match, and transitioning from multi- |
| | GEO match to a single GEO-match |
| 5) | Initiate recursive BSR to GEO-2: |
| | Build new PREF_LIST { s7(100) } |
| | Update the best channel found to be channel 450 |
| 6) | PREF_LIST has been exhausted because channel 100 was |
| | previously scanned. |
| 7) | Come back and acquire the best channel found: Channel 450 |
| 8) | Camp on s8 (channel 450) |

In scenario of Table (3) the conditions are the same as the scenario of Table (2), with the exception of s6 being removed. The legacy behavior results in the wireless communication device 102 camping on s8.

A wireless communication device 102 operating according to the described systems and methods may perform the new behavior of Table (3). The wireless communication device 102 may perform steps 1-4 as is done in the legacy behavior. However, upon finding s8 in step 4, the wireless communication device 102 determines that s8 is in a single GEO and transitioning from a multi-GEO match (s5) to a single GEO-match (s8). Therefore, the wireless communication device 102 initiates a recursive BSR scan for GEO-2.

The wireless communication device 102 builds a new preferred system list 112 that includes s7 (the system 104 in GEO-2 that is more preferred than s8). The wireless communication device 102 also updates the best channel found (e.g., Current_Pref_Chnl) to be channel 450. The wireless communication device 102 then initiates a recursive BSR scan. The wireless communication device 102 skips scanning channel 100 (e.g., s7) because it was scanned in step 3. At this point, the wireless communication device 102 determines that the preferred system list 112 has been exhausted. The wireless communication device 102 then returns to the best channel found (e.g., Current_Pref_Chnl) and camps on s8.

FIG. 5 is a flow diagram of a method 500 for performing a non-recursive BSR scan according to some embodiments. The method 500 may be performed by a wireless communication device 102. The wireless communication device 102 may acquire 502 a system 104. For example, the wireless communication device 102 may acquire 502 a system 104 during startup (e.g., during an out-of-service scan) or upon expiration of a periodic BSR timer (e.g., during a periodic BSR scan). In this case, the system ID 124 of the acquired system 104 may be in multiple GEOs. In other words, the wireless communication device 102 may be in a multi-GEO match.

In one embodiment, the wireless communication device 102 may store two variables associated with an acquired system 104. The variable Current_Pref_Sys may indicate the most preferred system that has been found. The variable Current_Pref_Chnl may indicate the channel/band on which the Current_Pref_Sys was found. If the wireless communication device 102 discovers a system 104 during scanning, the wireless communication device 102 may update the Current_Pref_Sys and the Current_Pref_Chnl to the more preferred system 104. In this case, Current_Pref_Sys may be set to the acquired system 104.

The wireless communication device 102 may build 504 a preferred system list 112 that includes all more preferred systems 104 in each GEO that includes the acquired system 104. This may be accomplished as described above in connection with FIG. 1. It should be noted that in this case, the system ID 124 of the acquired system 104 is in multiple GEOs. Therefore, the preferred system list 112 may include more preferred systems 104 from each of the multiple GEOs.

The wireless communication device 102 may perform 506 a BSR scan based on a preferred system list 112. The wireless communication device 102 may scan for systems 104 using the preferred system list 112. The wireless communication device 102 may scan more preferred systems 104 before scanning less preferred systems 104.

The wireless communication device 102 may find 508 a more preferred system 104 that has a system ID 124 in multiple GEOs. The wireless communication device 102 may set the discovered system 104 to be a base system 118 for a subsequent BSR scan.

The wireless communication device 102 may perform 510 a subsequent BSR scan using the existing preferred system list 112. In this case, because the system ID 124 of the base system 118 that was found in the prior BSR scan is included in multiple GEOs, the wireless communication device 102 does not know which GEO the base system 118 belongs to. Therefore, the wireless communication device 102 may perform 510 the subsequent BSR scan using the existing preferred system list 112. Because this is a multi-GEO match scenario, the wireless communication device 102 does not stop the subsequent BSR scan until one of the following conditions is met. The wireless communication device 102 may stop the subsequent BSR scan if a most preferred system 104 of a GEO has been found. The wireless communication device 102 may also stop the subsequent BSR scan when all the channels in the existing preferred system list 112 are scanned.

When the wireless communication device 102 discovers a system 104 during the subsequent BSR scan, the wireless communication device 102 may compare the discovered system 104 against the current base system 118. This may be accomplished according to 2.11.1 in CDMA Development Group (CDG) document 143, section 2.11.1. The wireless communication device 102 may update the current base system 118 (e.g., Current_Pref_Sys and Current_Pref_Chnl) if the discovered system 104 is more preferred than the current base system 118. The wireless communication device 102 may camp 512 on the best system 104 found, as indicated by the PRL 110.

An example of non-recursive BSR according to the described systems and methods is provided in Table (4). In the scenario included in Table (4), the non-recursive BSR scan results in a more preferred system 104 being discovered.

TABLE (4)
Scenario #4:

Given:

GEO-1 = { s1(750), s2(100), s3(450), s4(225, 250, 275),
s5(LTE.B13) }
GEO-2 = { s6(758), s7(100), s8(450), s5(LTE.B13) }
GEO-3 = { s9(525), s8(450), s5(LTE.B13) }

Scenario:

| | |
|---|---|
| • | The wireless communication device 102 is located in GEO-3 |
| • | Power up and acquire the s5 LTE system, which matches |
| | wildcard MCC = 311, MNC = 0XFFF |
| • | Channel 525 and Channel 450 are available |

Legacy Behavior:

| | |
|---|---|
| 1) | Acquire s5 (LTE) system |
| 2) | Build PREF_LIST contains: |
| | { s1(750), s2(100), s3(450), s4(225, 250, 275), s6(758), |
| | s9(525) } |
| | Note that s7 and s8 contain the same band/channel as |
| | s2 and s3 |
| 3) | Attempt to scan channel: 750 → FAILED, 100 → FAILED |
| 4) | Scanned channel 450, and found s8 |
| | Note: s8 is matched in GEO-2 & GEO-3 (multi-GEO match) |
| 5) | Camp on S8; Start periodic BSR |

New Behavior:

| | |
|---|---|
| 1) | Acquire s5 (LTE) system: s5 is a multi-GEO match |
| 2) | Build PREF_LIST that includes |
| | { s1(750), s2(100), s3(450), s4(225, 250, 275), s6(758), |
| | s9(525) } |
| | Note: s7 and s8 contain the same band/channel as s2 and s3 |
| 3) | Attempt to scan channel: 750 → FAILED, 100 → FAILED |
| 4) | Scanned channel 450, and found s8 in GEO-3 |
| | Note: s8 is a multi-GEO match, therefore, perform non- |
| | recursive BSR |
| 5) | Initiate non-recursive BSR: |
| | Continue using existing PREF_LIST |
| | Update the best channel found to be channel 450 |
| 6) | Attempt to scan channel: 225 → FAILED, 250 → FAILED, |
| | 275 → FAILED, 758 → FAILED, 525 → ACQUIRE |
| 7) | Compare s9(525) and s8(450): s9 > s8 |
| 8) | Camp on s9 (channel 525) |

In Table (4), a system 104 and channel/band are indicated as sX(Y), where X is a system number and Y is the channel number. For example, s1 (750) represents system 1, channel 750. The systems 104 are included in three GEOs (e.g., GEO-1, GEO-2 and GEO-3). This information may be provided in a PRL 110. It should be noted that each GEO has a common LTE system (e.g., s5 (LTE.B13)).

In this scenario, the wireless communication device 102 is located in GEO-3. Upon powering up, the wireless communication device 102 acquires the s5 LTE system. In this scenario, Channel 525 and Channel 450 are available. System s8 is included in both GEO-2 and GEO-3.

Table (1) describes the legacy behavior for this scenario. Upon acquiring s5, the wireless communication device 102 would build a preferred system list 112 (e.g., PREF_LIST) that includes the more preferred systems 104 from each GEO that includes s5. The systems 104 are included in the preferred system list 112 based on order of preference. However, s7 and s8 are excluded because they contain the same channel/band as s2 and s3, respectively.

The wireless communication device 102 operating according to legacy behavior performs a BSR scan. The wireless communication device 102 attempts to scan channel 750 (e.g., s1) and channel 100 (e.g., s2), but these scans fail. However, the scan of channel 450 is successful for channel 450 finds s8 in GEO-2 and GEO-3. According to legacy behavior, the wireless communication device 102 then camps on s8 and starts a periodic BSR timer. However, s8 is not the more preferred system 104 in GEO-3.

A wireless communication device 102 operating according to the described systems and methods may perform the new behavior of Table (4). The wireless communication device 102 may perform steps 1-4 as is done in the legacy behavior. However, upon finding s8 in step 4, the wireless communication device 102 determines that the frequency (e.g., channel) of s8 is in multiple GEOs and transitioning from a multi-GEO match (s5) to a multi-GEO match (s8). Therefore, the wireless communication device 102 initiates a non-recursive BSR scan.

The wireless communication device 102 continues using the existing preferred system list 112. The wireless communication device 102 also updates the best channel found (e.g., Current_Pref_Chnl) to be channel 450. The wireless communication device 102 then performs a subsequent BSR scan. The wireless communication device 102 attempts to scan channel 525 (e.g., s9). Because channel 758 is available, the wireless communication device 102 acquires channel 525 on s9. The wireless communication device 102 then compares s9 to s8. Because s9 is more preferred than s8 in GEO-3, the wireless communication device 102 camps on s9. Therefore, by performing non-recursive BSR, the wireless communication device 102 found the most preferred system 104 in GEO-3.

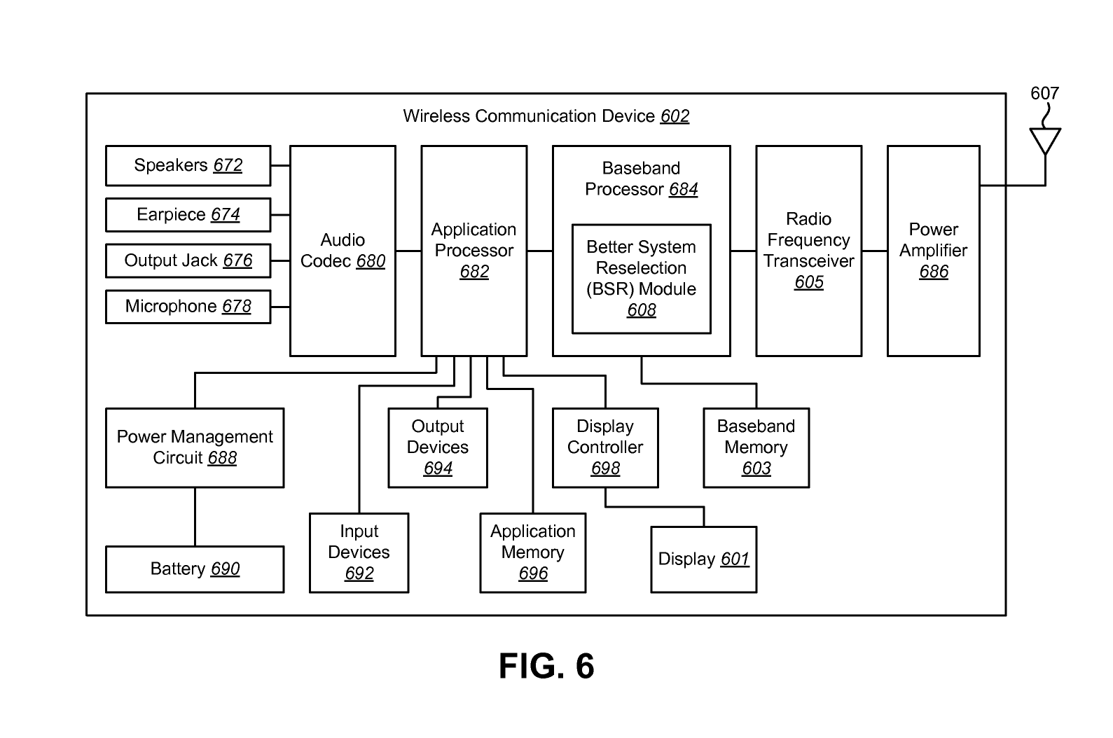

FIG. 6 is a block diagram illustrating one configuration of a wireless communication device 602 in which systems and methods for performing BSR may be implemented according to some embodiments. The wireless communication device 602 illustrated in FIG. 6 may include the wireless communication device 102 and/or other devices/circuitries described above. The wireless communication device 602 may include an application processor 682. The application processor 682 generally processes instructions (e.g., runs programs) to perform functions on the wireless communication device 602. The application processor 682 may be coupled to an audio coder/decoder (codec) 680.

The audio codec 680 may be an electronic device (e.g., integrated circuit) used for coding and/or decoding audio signals. The audio codec 680 may be coupled to one or more speakers 672, an earpiece 674, an output jack 676 and/or one or more microphones 678. The speakers 672 may include one or more electro-acoustic transducers that convert electrical or electronic signals into acoustic signals. For example, the speakers 672 may be used to play music or output a speakerphone conversation, etc. The earpiece 674 may be another speaker or electro-acoustic transducer that can be used to output acoustic signals (e.g., speech signals) to a user. For example, the earpiece 674 may be used such that only a user may reliably hear the acoustic signal. The output jack 676 may be used for coupling other devices to the wireless communication device 602 for outputting audio, such as headphones. The speakers 672, earpiece 674 and/or output jack 676 may generally be used for outputting an audio signal from the audio codec 680. The one or more microphones 678 may be acousto-electric transducer that converts an acoustic signal (such as a user's voice) into electrical or electronic signals that are provided to the audio codec 680.

The application processor 682 may also be coupled to a power management circuit 688. One example of a power management circuit 688 is a power management integrated circuit (PMIC), which may be used to manage the electrical power consumption of the wireless communication device 602. The power management circuit 688 may be coupled to a battery 690. The battery 690 may generally provide electrical power to the wireless communication device 602. For example, the battery 690 and/or the power management circuit 688 may be coupled to one or more of the elements included in the wireless communication device 602.

The application processor 682 may be coupled to one or more input devices 692 for receiving input. Examples of input devices 692 include infrared sensors, image sensors, accelerometers, touch sensors, keypads, etc. The input devices 692 may allow user interaction with the wireless communication device 602. The application processor 682 may also be coupled to one or more output devices 694. Examples of output devices 694 include printers, projectors, screens, haptic devices, etc. The output devices 694 may allow the wireless communication device 602 to produce output that may be experienced by a user.

The application processor 682 may be coupled to application memory 696. The application memory 696 may be any electronic device that is capable of storing electronic information. Examples of application memory 696 include double data rate synchronous dynamic random access memory (DDRAM), synchronous dynamic random access memory (SDRAM), flash memory, etc. The application memory 696 may provide storage for the application processor 682. For instance, the application memory 696 may store data and/or instructions for the functioning of programs that are run on the application processor 682.

The application processor 682 may be coupled to a display controller 698, which in turn may be coupled to a display 601. The display controller 698 may be a hardware block that is used to generate images on the display 601. For example, the display controller 698 may translate instructions and/or data from the application processor 682 into images that can be presented on the display 601. Examples of the display 601 include liquid crystal display (LCD) panels, light emitting diode (LED) panels, cathode ray tube (CRT) displays, plasma displays, etc.

The application processor 682 may be coupled to a baseband processor 684. The baseband processor 684 generally processes communication signals. For example, the baseband processor 684 may demodulate and/or decode received signals. Additionally or alternatively, the baseband processor 684 may encode and/or modulate signals in preparation for transmission.

The baseband processor 684 may be coupled to baseband memory 603. The baseband memory 603 may be any electronic device capable of storing electronic information, such as SDRAM, DDRAM, flash memory, etc. The baseband processor 684 may read information (e.g., instructions and/or data) from and/or write information to the baseband memory 603. Additionally or alternatively, the baseband processor 684 may use instructions and/or data stored in the baseband memory 603 to perform communication operations.

The baseband processor 684 may include a BSR module 608 for performing BSR scans according to the systems and methods disclosed herein. The BSR module 608 may be configured similarly to the BSR module 108 described herein. Additionally or alternatively, the BSR module 608 may perform one or more of the methods 200, 300, 400, 500 and/or one or more of the functions described in connection with one or more of the BSR module 108 described above. In some configurations, the BSR module 608 may be alternatively implemented independently from the baseband processor 684.

The baseband processor 684 may be coupled to a radio frequency (RF) transceiver 605. The RF transceiver 605 may be coupled to a power amplifier 686 and one or more antennas 607. The RF transceiver 605 may transmit and/or receive radio frequency signals. For example, the RF transceiver 605 may transmit an RF signal using a power amplifier 686 and one or more antennas 607. The RF transceiver 605 may also receive RF signals using the one or more antennas 607.

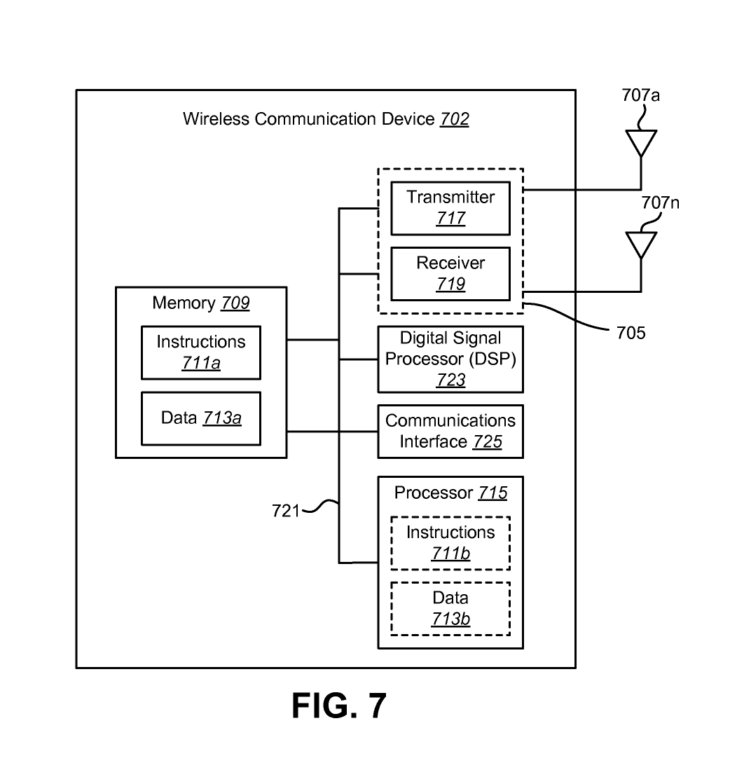

FIG. 7 illustrates certain components that may be included within a wireless communication device 702 according to some embodiments. The wireless communication device 702 may be implemented in accordance with the wireless communication device 102 described above. The wireless communication device 702 may be an access terminal, a mobile station, a user equipment, etc. The wireless communication device 702 includes a processor 715. The processor 715 may be a general purpose single- or multi-chip microprocessor (e.g., an ARM), a special purpose microprocessor (e.g., a digital signal processor (DSP)), a microcontroller, a programmable gate array, etc. The processor 715 may be referred to as a central processing unit (CPU). Although just a single processor 715 is shown in the wireless communication device 702 of FIG. 7, in an alternative configuration, a combination of processors (e.g., an ARM and DSP) could be used.

The wireless communication device 702 also includes memory 709. The memory 709 may be any electronic component capable of storing electronic information. The memory 709 may be embodied as random access memory (RAM), read-only memory (ROM), magnetic disk storage media, optical storage media, flash memory devices in RAM, on-board memory included with the processor, erasable programmable read-only memory (EPROM), electrically erasable PROM (EEPROM), registers and so forth, including combinations thereof.

Data 713a and instructions 711a may be stored in the memory 709. The instructions 711a may be executable by the processor 715 to implement the methods disclosed herein. Executing the instructions 711a may involve the use of the data 713a that is stored in the memory 709. When the processor 715 executes the instructions 711a, various portions of the instructions 711b may be loaded onto the processor 715, and various pieces of data 713b may be loaded onto the processor 715.

The wireless communication device 702 may also include a transmitter 717 and a receiver 719 to allow transmission and reception of signals to and from the wireless communication device 702. The transmitter 717 and receiver 719 may be collectively referred to as a transceiver 705. Multiple antennas 707a-n may be electrically coupled to the transceiver 705. The wireless communication device 702 may also include (not shown) multiple transmitters, multiple receivers, multiple transceivers and/or additional antennas.

The wireless communication device 702 may include a digital signal processor (DSP) 723. The wireless communication device 702 may also include a communications interface 725. The communications interface 725 may allow a user to interact with the wireless communication device 702.

The various components of the wireless communication device 702 may be coupled together by one or more buses, which may include a power bus, a control signal bus, a status signal bus, a data bus, etc. For the sake of clarity, the various buses are illustrated in FIG. 7 as a bus system 721.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 2-5, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized. For example, some of the methods described herein may be performed by a processor 803, one or more local oscillators (LOs), a wideband receiver fast Fourier transform (FFT) hardware, software and/or firmware.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for wireless communication, comprising:
performing a Better System Reselection (BSR) scan for systems;
finding a base system to camp on that is not a most preferred system; and
determining whether to perform a recursive BSR scan starting from the base system found in the prior BSR scan.

2. The method of claim 1, further comprising skipping, during the recursive BSR scan, any channels or frequency bands that were scanned in a prior BSR scan.

3. The method of claim 1, wherein the recursive BSR scan comprises performing one or more BSR scans, wherein each subsequent BSR scan comprises:
building a new preferred system list that includes one or more systems that are more preferred than the base system of the prior BSR scan;
scanning for the one or more systems included in the new preferred system list; and
updating the base system with a more preferred system found during the subsequent BSR scan.

4. The method of claim 3, wherein the recursive BSR scan further comprises:
stopping the recursive BSR scan when a preferred system list is exhausted or a most preferred system is found; and
camping on the best system available.

5. The method of claim 1, wherein determining that the base system is not a most preferred system is based on a preferred roaming list (PRL).

6. The method of claim 5, further comprising determining whether a system identification (ID) of the base system is in a single geographic area or multiple geographic areas based on the PRL.

7. The method of claim 6, wherein if the system ID of the base system is in a single geographic area, then the method further comprises:
performing the recursive BSR scan using a new preferred system list.

8. The method of claim 6, wherein if the system ID of the base system is in multiple geographic areas, then the method further comprises:
performing a subsequent BSR scan using an existing preferred system list from the prior BSR scan.

9. The method of claim 8, wherein a most preferred system is a system that is most preferred in a geographic area as defined by a preferred roaming list (PRL).

10. The method of claim 1, further comprising comparing a system found during the recursive BSR scan to the base system to determine which system is more preferred.

11. An apparatus for wireless communication, comprising:
a processor;
memory in electronic communication with the processor; and
instructions stored in the memory, the instructions being executable by the processor to:
perform a Better System Reselection (BSR) scan for systems;
find a base system to camp on that is not a most preferred system; and
determine whether to perform a recursive BSR scan starting from the base system found in the prior BSR scan.

12. The apparatus of claim 11, wherein the recursive BSR scan comprises instructions executable to perform one or more BSR scans, wherein each subsequent BSR scan comprises instructions executable to:
build a new preferred system list that includes one or more systems that are more preferred than the base system of the prior BSR scan;
scan for the one or more systems included in the new preferred system list; and
update the base system with a more preferred system found during the subsequent BSR scan.

13. The apparatus of claim 12, wherein the recursive BSR scan further comprises instructions executable to:
stop the recursive BSR scan when a preferred system list is exhausted or a most preferred system is found; and
camp on the best system available.

14. The apparatus of claim 11, wherein if a system identification (ID) of the base system is in a single geographic area, then the instructions are further executable to:
perform the recursive BSR scan using a new preferred system list.

15. The apparatus of claim 11, wherein if a system identification (ID) of the base system is in multiple geographic areas, then the instructions are further executable to:
perform a subsequent BSR scan using an existing preferred system list from the prior BSR scan.

16. A wireless device, comprising:
means for performing a better system reselection (BSR) scan for systems;
means for finding a base system to camp on that is not a most preferred system; and
means for determining whether to perform a recursive BSR scan starting from the base system found in the prior BSR scan.

17. The wireless device of claim 16, wherein the recursive BSR scan comprises means for performing one or more BSR scans, wherein each subsequent BSR scan comprises:
means for building a new preferred system list that includes one or more systems that are more preferred than the base system of the prior BSR scan;
means for scanning for the one or more systems included in the new preferred system list; and
means for updating the base system with a more preferred system found during the subsequent BSR scan.

18. The wireless device of claim 16, wherein the recursive BSR scan further comprises:
means for stopping the recursive BSR scan when a preferred system list is exhausted or a most preferred system is found; and
means for camping on the best system available.

19. The wireless device of claim 16, wherein if a system identification (ID) of the base system is in a single geographic area, then the wireless device further comprises:
means for performing the recursive BSR scan using a new preferred system list.

20. The wireless device of claim 16, wherein if a system identification (ID) of the base system is in multiple geographic areas, then the wireless device further comprises:
means for performing a subsequent BSR scan using an existing preferred system list from the prior BSR scan.
